(19) United States
(12) Patent Application Publication
(10) Pub. No.: US 2012/0331322 A1
(43) Pub. Date: Dec. 27, 2012

(54) POWER-SUPPLY CONTROL SYSTEM, POWER-SUPPLY CONTROL METHOD, AND IMAGE FORMING APPARATUS

(75) Inventor: Satoshi SUZUKI, Kanagawa (JP)

(73) Assignee: RICOH COMPANY, LIMITED, Tokyo (JP)

(21) Appl. No.: 13/523,338

(22) Filed: Jun. 14, 2012

(30) Foreign Application Priority Data
Jun. 23, 2011 (JP) 2011-139720

(51) Int. Cl. G06F 1/32; G06F 1/26

(52) U.S. Cl. 713/323; 713/300

(57) ABSTRACT

A power-supply control system includes a plurality of apparatuses connected to each other. Each apparatus includes a battery configured to supply power in a power saving mode where power consumption is lower than in a normal mode; a detecting unit configured to detect an output voltage of the battery; a transmitting unit configured to transmit a power supply request when the output voltage is determined to be lower than a predetermined value; a receiving unit configured to receive a request from another apparatus; a determining unit configured to determine whether the battery is available for the another apparatus in response to the request; and a control unit configured to control power supply from the battery. The control unit transmits a notification of power supply start to the another apparatus and causes the battery to supply power to the another apparatus when the battery is available for the another apparatus.

### CROSS-REFERENCE TO RELATED APPLICATIONS

The present application claims priority to and incorporates by reference the entire contents of Japanese Patent Application No. 2011-139720 filed in Japan on Jun. 23, 2011.

### BACKGROUND OF THE INVENTION

1. Field of the Invention

The present invention relates to a power-supply control system, a power-supply control method, and an image forming apparatus.

2. Description of the Related Art

Proposed and known are power-supply intermediate apparatuses or means that control apparatuses each having a rechargeable battery so as to charge a battery of one apparatus that needs to be charged more seriously (having higher priority) with power supplied from a battery of another apparatus having lower priority. Using such a power-supply intermediate apparatus or means can lead to reduction in electricity cost by, for example, charging batteries during nighttime or the like to thereby minimize electricity supplied from a commercial power source during daytime.

Disclosed in Japanese Patent Application Laid-open No. 2009-277014 is a configuration that intermediates daytime power supply to terminals that are capable of battery-powered operations. According to the configuration disclosed in Japanese Patent Application Laid-open No. 2009-277014, it is possible to reduce electricity cost for use by the terminals and to level electricity demand.

A power supply method using a conventional power-supply intermediate apparatus involves addition of an apparatus that performs centralized management of power receiving and power supply and therefore can result in increase in cost and complexity of a system. To avoid such disadvantage, it is possible to cause one of multiple apparatuses that are connected to each other to have a management function of managing power receiving and power supply.

However, in such a system that one of the multiple apparatuses has the management function of managing power receiving and power supply, it is necessary to continuously place the apparatus having the management function in an operating state. This causes a problem that it is difficult to reduce power consumption of the apparatus. There arises another problem that the management of power receiving and power supply of the multiple apparatuses fails in an event of failure of the apparatus having the management function.

In the technique disclosed in Japanese Patent Application Laid-open No. 2009-277014, a power-supply hub controls power receiving and power supply of the multiple terminals by monitoring power-supply states of the multiple terminals. Accordingly, the problem that it is difficult to reduce power requirement of the management apparatus and the problem that can occur when the management apparatus fails are not solved by this technique.

Therefore, there is a need for a system capable of controlling power supply and power receiving between batteries of apparatuses without using an apparatus that performs centralized management.

### SUMMARY OF THE INVENTION

It is an object of the present invention to at least partially solve the problems in the conventional technology.

According to an embodiment, there is provided a power-supply control system that includes a plurality of apparatuses connected to each other. Each of the apparatuses includes a battery configured to supply power in a power saving mode where power consumption is lower than in a normal mode; a detecting unit configured to detect an output voltage of the battery; a transmitting unit configured to transmit a power supply request when the output voltage is determined to be lower than a predetermined value; a receiving unit configured to receive a power supply request from another apparatus; a determining unit configured to determine whether the battery is available; and a power-supply control unit configured to control power supply from the battery. The determining unit determines whether the battery is available for the another apparatus in response to the power supply request. The power-supply control unit transmits a notification of power supply start to the another apparatus and causes the battery to supply power to the another apparatus when the determining unit determines that the battery is available for the another apparatus.

According to another embodiment, there is provided a power-supply control method that includes detecting, by a detecting unit, an output voltage of a battery; transmitting, by a transmitting unit, a power supply request when the output voltage is determined to be lower than a predetermined value; receiving, by a receiving unit, a power supply request from an apparatus; determining, by a determining unit, whether the battery is available; and controlling, by a power-supply control unit, power supply from the battery. The determining includes determining whether the battery is available for the apparatus in response to the power supply request. The controlling includes transmitting a notification of power supply start to the apparatus and causing the battery to supply power to the apparatus when the battery is available for the apparatus.

According to still another embodiment, there is provided an image forming apparatus that includes an image forming unit configured to form an image based on image data; a detecting unit configured to detect an output voltage of a battery; a transmitting unit configured to transmit a power supply request when the output voltage is determined to be lower than a predetermined value; a receiving unit configured to receive a power supply request from an apparatus; a determining unit configured to determine whether the battery is available; and a power-supply control unit configured to control power supply from the battery. The determining unit determines whether the battery is available for the another apparatus in response to the power supply request. The power-supply control unit transmits a notification of power supply start to the another apparatus and causes the battery to supply power to the another apparatus when the determining unit determines that the battery is available for the another apparatus. The power-supply control unit feeds power supplied in response to the power supply request transmitted by the transmitting unit, to the image forming unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating an example configuration of a power-supply control system to which an embodiment of the present invention is applicable;

FIG. 2 is a block diagram illustrating an example configuration of a subunit;

FIG. 3 is a sequence diagram for schematically explaining a procedure for controlling power-supply processing according to the embodiment;

FIG. 4 illustrates an example of a relation between operation time and battery output voltage in a power saving mode;

FIG. 5 is a flowchart illustrating an example processing sequence for a power supply requester;

FIG. 6 is a flowchart illustrating an example processing sequence to be performed when the power supply requester receives a power-supply stop notification from a power supplier;

FIG. 7 is a flowchart illustrating an example processing sequence for the power supplier; and

FIG. 8 is a schematic diagram illustrating an example of a relation between operation time and battery output voltage in a power saving mode.

### DETAILED DESCRIPTION OF THE PREFERRED EMBODIMENTS

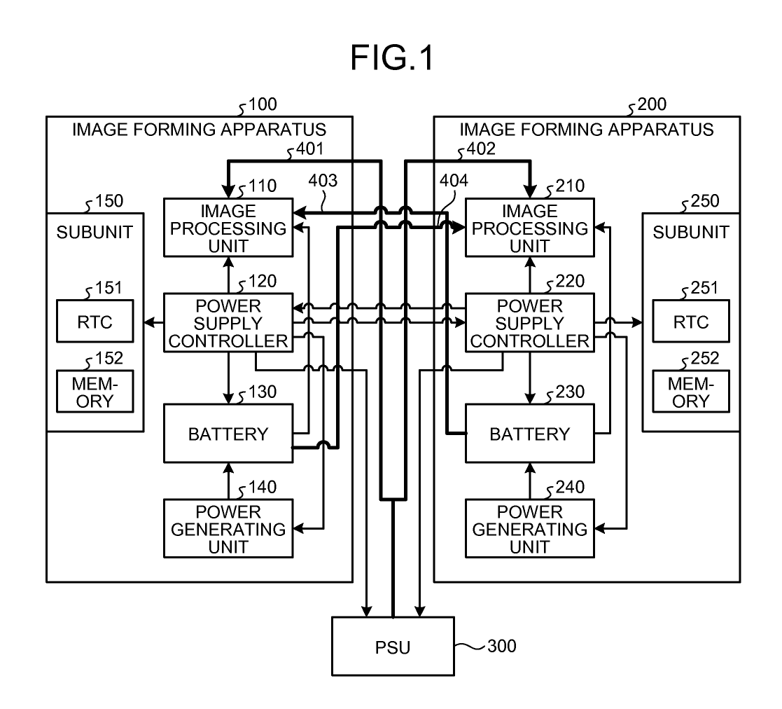

Exemplary embodiments of the present invention are described in detail below with reference to the accompanying drawings. FIG. 1 illustrates an example configuration of a power-supply control system to which an embodiment of the present invention is applicable. It is assumed in the description below that each of apparatuses in the power-supply control system is an image forming apparatus that forms an image on a sheet or the like according to image data.

In FIG. 1, an image forming apparatus 100 includes an image processing unit 110, a power supply controller 120, a battery 130, a power generating unit 140, and a subunit 150. A power supply unit (PSU) 300 to which commercial power source, for example, is supplied generates power source to be supplied to the image forming apparatus 100 and an image forming apparatus 200, which will be described later, from this commercial power source. In the example illustrated in FIG. 1, the PSU 300 is provided to be shared between the image forming apparatus 100 and the image forming apparatus 200; however, employable configuration is not limited to this example. For example, each of the image forming apparatuses 100 and 200 may include its own PSU.

The image processing unit 110 includes a printer engine unit, for example. The image processing unit 110 performs predetermined image processing on image data that is externally fed and causes the printer engine unit and the like to form an image on a sheet or the like according to the image data. The configuration of the image processing unit 110 is not limited thereto, and the image processing unit 110 may be configured to further have a scanner function and cause the printer engine unit to print image data obtained by scanning using the scanner function.

The battery 130 is a rechargeable battery. The power generating unit 140 generates power by photovoltaic power generation or the like. The power supply controller 120 controls power source supply to each of units of the image forming apparatus 100, detection of conditions of the battery 130, and charging and discharging of the battery 130.

For example, the power supply controller 120 performs control of determining which one of the power generated by the power generating unit 140 and the power source supplied from the PSU 300 is to be used to charge the battery 130 based on the detected conditions of the battery 130. The power supply controller 120 can reduce use of the commercial power source by performing the control in a manner such that the battery 130 is charged with the power generated by the power generating unit 140 as much as possible so as to minimize charging with the power source supplied from the PSU 300.

The power supply controller 120 also performs control of switching an operation mode of the image forming apparatus 100 between a normal mode and a power saving mode. In the power saving mode, power consumption is smaller than that in the normal mode. When the normal mode is selected as the operation mode of the image forming apparatus 100, the power supply controller 120 selects the PSU 300 as a power source of the image processing unit 110. When the power saving mode is selected as the operation mode of the image forming apparatus 100, the power supply controller 120 selects one of the battery 130, the PSU 300, and a battery 230 of the image forming apparatus 200, which will be described later, as the power source of the image processing unit 110 based on the detected conditions of the battery 130.

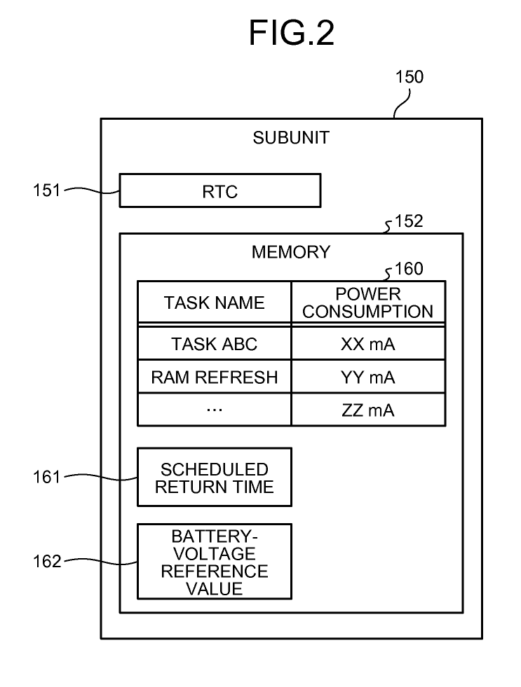

The subunit 150 includes a real time clock (RTC) 151 and a memory 152. FIG. 2 illustrates an example configuration of the subunit 150. The RTC 151 obtains current time by measurement. The memory 152 stores a task list 160, scheduled return time 161, and a battery-voltage reference value 162.

Stored in the task list 160 are tasks to be processed by the image forming apparatus 100 and power consumption per unit time of each of the tasks associated therewith. The scheduled return time 161 is information indicating time at which the image forming apparatus 100 is scheduled to return from the power saving mode. The scheduled return time 161 is set when the image forming apparatus 100 enters the power saving mode. The battery-voltage reference value 162 is a reference value for the voltage of the battery 130 at which there arises a necessity to start charging the battery 130 with power supplied from an external power source (e.g., the PSU 300) in the power saving mode.

Although not shown, a subunit 250 of the image forming apparatus 200 has a configuration similar to that of the subunit 150. More specifically, the subunit 250 includes an RTC 251 and a memory 252. The memory 252 stores a task list, scheduled return time, and a battery-voltage reference value related to the image forming apparatus 200.

Referring back to FIG. 1, the configuration of the image forming apparatus 200 is substantially equal to that of the image forming apparatus 100. More specifically, the image forming apparatus 200 includes an image processing unit 210, a power supply controller 220, the battery 230, a power generating unit 240, and the subunit 250. Each of the image processing unit 210, the power supply controller 220, the battery 230, the power generating unit 240, and the subunit 250 has a function of a corresponding one of the image processing unit 110, the power supply controller 120, the battery 130, the power generating unit 140, and the subunit 150 of the image forming apparatus 100. Accordingly, repeated descriptions about the units are omitted.

In the configuration described above, a feed line 401 and a feed line 402 from the PSU 300 are connected to the image processing unit 110 of the image forming apparatus 100 and the image processing unit 210 of the image forming apparatus 200, respectively. Each of the image processing units 110 and 210 receives power source supplied from the PSU 300. The power source from the PSU 300 is supplied to each of the entire image forming apparatus 100 and the entire image forming apparatus 200 in practice, and the batteries 130 and 230 can be charged with power supplied from the PSU 300.

The output of the battery 130 is supplied to the image processing unit 110 of the image forming apparatus 100. The battery 130 and the image forming apparatus 200 are connected with a feed line 404, allowing the output of the battery 130 to be supplied to the image processing unit 210. Similarly, the output of the battery 230 is supplied to the image processing unit 210 of the image forming apparatus 200; the battery 230 and the image forming apparatus 100 are connected with a feed line 403, allowing the output of the battery 230 to be supplied the image processing unit 110.

The power supply controller 120 of the image forming apparatus 100 and the power supply controller 220 of the image forming apparatus 200 are connected via a communication port (not shown), allowing the power supply controller 120 and the power supply controller 220 to carry out communications therebetween. The power supply controller 120 is connected to the PSU 300 in a fashion such that the power supply controller 120 can control power supply through the feed line 401. Similarly, the power supply controller 220 is connected to the PSU 300 in a fashion such that the power supply controller 220 can control power supply through the feed line 402.

The image forming apparatus 100 in the power saving mode is operated only by power supplied from the battery 130. The power supply controller 120 transmits a power supply request to the image forming apparatus 200 rather than performing control so as to receive power supply from the PSU 300 when the output voltage of the battery 130 of the image forming apparatus 100 in the power saving mode becomes lower than a predetermined boundary value, for example. Upon receiving the power supply request, the power supply controller 220 of the image forming apparatus 200 calculates surplus power of the battery 230 estimated based on the output voltage of the battery 230 and tasks to be processed during the power saving mode. The power supply controller 220 starts power supply to the image forming apparatus 100 by supplying the output voltage of the battery 230 to the image forming apparatus 100 through the feed line 403 when the power supply controller 220 determines that power is suppliable from the battery 230 to the image forming apparatus 100 based on the calculated surplus power of the battery 230.

The power supply controller 220 of the image forming apparatus 200 estimates power consumption in a period until the scheduled return time comes using the task list and the scheduled return time stored in the memory 252 of the subunit 250. When the power supply controller 220 determines that power is suppliable, the power supply controller 220 transmits a power-supply-start notification to the power supply controller 120. Thus, power can be supplied from the image forming apparatus 200 to the image forming apparatus 100 without using an additionally-provided intermediate apparatus that intermediates power supply.

Meanwhile, the operations described above are similarly applicable to a situation where the image forming apparatus 100 and the image forming apparatus 200 are interchanged.

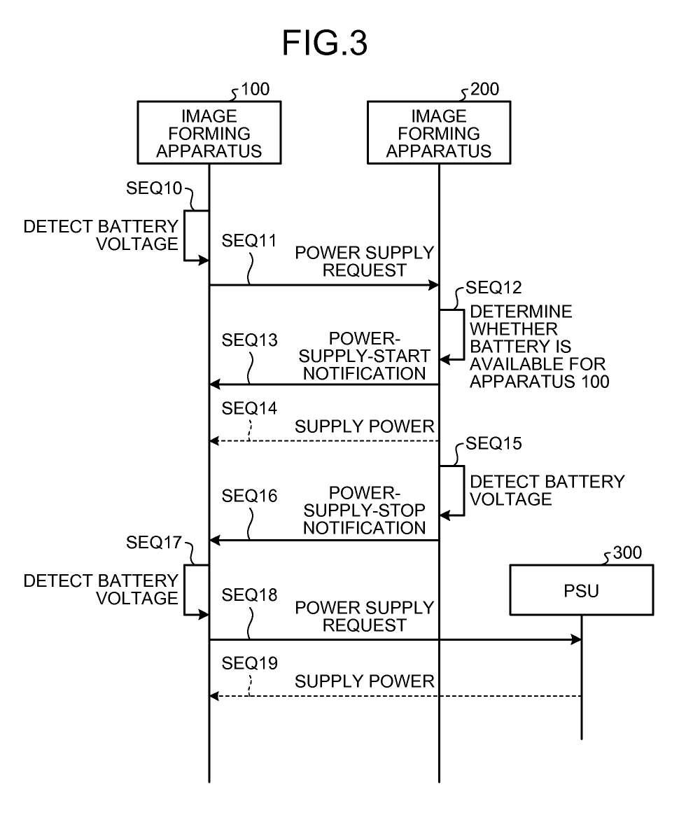

A procedure for controlling power-supply processing according to the embodiment is schematically described below with reference to the sequence diagram illustrated in FIG. 3. FIG. 3 illustrates an example procedure for controlling power-supply processing to be performed in the power saving mode in a situation where the image forming apparatus 100 requests the image forming apparatus 200 to supply power.

It is assumed that the operation modes of the image forming apparatus 100 and the image forming apparatus 200 have shifted from the normal mode to the power saving mode before the operations illustrated in FIG. 3 are performed. The power supply controller 120 controls the image forming apparatus 100 so as to receive power source supply from the battery 130 during the power saving mode. Similarly, the image forming apparatus 200 receives power source supply from the battery 230 during the power saving mode. When the image forming apparatus 100 enters the power saving mode, scheduled return time at which the image forming apparatus 100 is scheduled to return from the power saving mode to the normal mode is set and stored in the memory 152 as the scheduled return time 161. Scheduled return time at which the image forming apparatus 200 is scheduled to return from the power saving mode to the normal is similarly set and stored in the memory 252 (not shown).

For example, the power supply controller 120 of the image forming apparatus 100 monitors the output voltage of the battery 130 and compares the thus-detected output voltage with the battery-voltage reference value 162 stored in the memory 152 of the subunit 150 (SEQ10). The power supply controller 120 transmits a power supply request to the power supply controller 220 when the output voltage of the battery 130 is determined to be lower than the battery-voltage reference value 162, for example, as a result of the comparison (SEQ11). This power supply request is transmitted with information about a minimum amount of power necessary for the image forming apparatus 100 to maintain the power saving mode added thereto.

In response to the power supply request from the image forming apparatus 100, the power supply controller 220 of the image forming apparatus 200 detects conditions of the battery 230 included in the image forming apparatus 200 to determine whether the battery 230 is available for the image forming apparatus 100 (SEQ12). More specifically, the power supply controller 220 detects the output voltage of the battery 230, and also determines whether the battery 230 is available for the image forming apparatus 100 based on information including the task list and the scheduled return time stored in the memory 252, and the amount of minimum power transmitted from the image forming apparatus 100 at SEQ11.

Upon determining that power is suppliable, the power supply controller 220 transmits a power-supply-start notification to the power supply controller 120 of the image forming apparatus 100 (SEQ13) to notify the power supply controller 120 that power supply from the battery 230 is to be started. Thereafter, the power supply controller 220 performs control in a manner such that the output voltage of the battery 230 is supplied to the image forming apparatus 100 through the feed line 403 (SEQ14).

Note that even when the output voltage of the battery 230 is supplied to the image forming apparatus 100, supplying the output voltage of the battery 230 to the image forming apparatus 200 is continued.

After power supply to the image forming apparatus 100 is started, the power supply controller 220 monitors the output voltage of the battery 230 and compares the thus-detected output voltage with the battery-voltage reference value stored in the memory 252 of the subunit 250 (SEQ15). The power supply controller 220 transmits a power-supply-stop notification to the power supply controller 120 to notify that power supply from the battery 230 is to be stopped when the output voltage of the battery 230 is determined to be lower than the battery-voltage reference value and cannot maintain the power saving mode, for example, as a result of the comparison (SEQ16).

When the power supply controller 120 of the image forming apparatus 100 receives this power-supply-stop notification, the power supply controller 120 detects the output voltage of the battery 130 and compares the detected output voltage with the battery-voltage reference value 162 stored in the memory 152 of the subunit 150 (SEQ17). The power supply controller 120 transmits a power supply request to the PSU 300 to request that power be supplied to the image forming apparatus 100 when the output voltage of the battery 130 is determined to be lower than the battery-voltage reference value 162 and cannot maintain the power saving mode as a result of the comparison (SEQ18). The PSU 300 supplies power to the image forming apparatus 100 through the feed line 401 in response to this request (SEQ19).

In the operations described above, the power supply controller 120 may alternatively perform control in a manner such that power supply from the PSU 300 is started immediately when a response to the power supply request transmitted at SEQ11 is not returned from the image forming apparatus 200 within predetermined time.

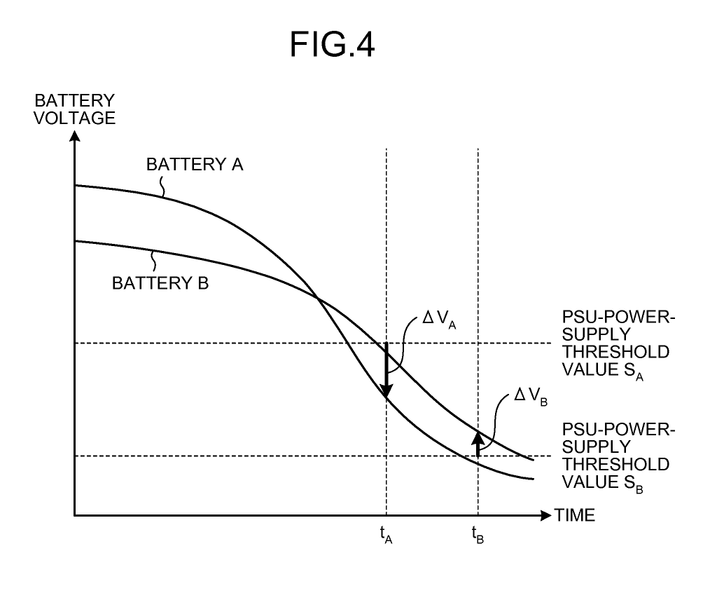

Determination as to whether the battery 230 is available for the image forming apparatus 100 at SEQ12 in response to the power supply request is described in more detail below. FIG. 4 illustrates an example of a relation between operation time and battery output voltage in the power saving mode. In FIG. 4, the horizontal axis represents time, and the vertical axis represents the output voltage of the battery. In FIG. 4, the battery 130 included in the image forming apparatus 100 is indicated as battery A, and the battery 230 included in the image forming apparatus 200 is indicated as battery B.

For example, in the image forming apparatus 100, a threshold value for the output voltage of the battery 130, or the battery-voltage reference value 162, at which power source in the power saving mode is to be switched from the battery 130 (battery A) to the PSU 300 is referred to as a PSU-power-supply threshold value S_{A}. Similarly, a corresponding threshold value for the output voltage of the battery 230 (battery-voltage reference value) of the image forming apparatus 200 is referred to as a PSU-power-supply threshold value S_{B}.

Time at which the image forming apparatus 100 is scheduled to return from the power saving mode and time at which the image forming apparatus 200 is scheduled to return from the power saving mode are referred to as scheduled return time t_{A} and scheduled return time t_{B}, respectively. The battery-voltage reference value 162 and the scheduled return time t_{A} are stored in the memory 152. Similarly, the battery-voltage reference value and scheduled return time t_{B} of the image forming apparatus 200 are stored in the memory 252.

The battery 130 (battery A) and the battery 230 (battery B) differ from each other in rate of output-voltage decrease. This difference is caused by differences in charged amount and charging/discharging characteristics, and differences between the image forming apparatus 100 in which the battery 130 is included and the image forming apparatus 200 in which the battery 230 is included in average power consumption and tasks to be processed during the power saving mode. In the example illustrated in FIG. 4, the rate of output-voltage decrease of the battery 130 (battery A) is higher than that of the battery 230 (battery B).

When the output voltage of the battery 130 has become lower than the PSU-power-supply threshold value S_{A}, the image forming apparatus 100 needs to be supplied with power from the PSU 300. Similarly, when the output voltage of the battery 230 has become lower than the PSU-power-supply threshold value S_{B}, the image forming apparatus 200 needs to be supplied with power from the PSU 300.

As illustrated in FIG. 4, it is assumed that the PSU-power-supply threshold value S_{A} is set to a value higher than the PSU-power-supply threshold value S_{B}, and the scheduled return time t_{A} is set to time earlier than the scheduled return time t_{B}. In this example, the output voltage of the battery 130 of the image forming apparatus 100 is already lower than the PSU-power-supply threshold value S_{A} at the scheduled return time t_{A} at which the image forming apparatus 100 returns from the power saving mode; more specifically, the output voltage is lower than the PSU-power-supply threshold value A by voltage ΔV_{A}.

Meanwhile, in the image forming apparatus 200, the output voltage of the battery 230 is higher than the PSU-power-supply threshold value S_{B} at the scheduled return time t_{B}; more specifically, the output voltage is higher than the PSU-power-supply threshold value S_{B} by voltage ΔV_{B}. Put another way, the battery 230 has surplus power corresponding to the voltage ΔV_{B} at the scheduled return time t_{B}.

At an instant when the output voltage of the battery 130 reaches the PSU-power-supply threshold value S_{A}, the image forming apparatus 100 transmits a power supply request to the image forming apparatus 200. The image forming apparatus 200 calculates surplus power of the battery 230 in response to the power supply request. The image forming apparatus 200 determines whether the battery 230 is available for the image forming apparatus 100 based on the calculated surplus power. In this example, the output voltage of the battery 230 at the scheduled return time t_{B} is higher than the PSU-power-supply threshold value S_{B} in the image forming apparatus 200. Accordingly, it is determined that the image forming apparatus 200 can supply power to the image forming apparatus 100. The power supply controller 120 obtains such relation between output voltage of the battery 130 and operation time in the power saving mode; the power supply controller 220 obtains such relation between output voltage of the battery 230 and operation time in the power saving mode.

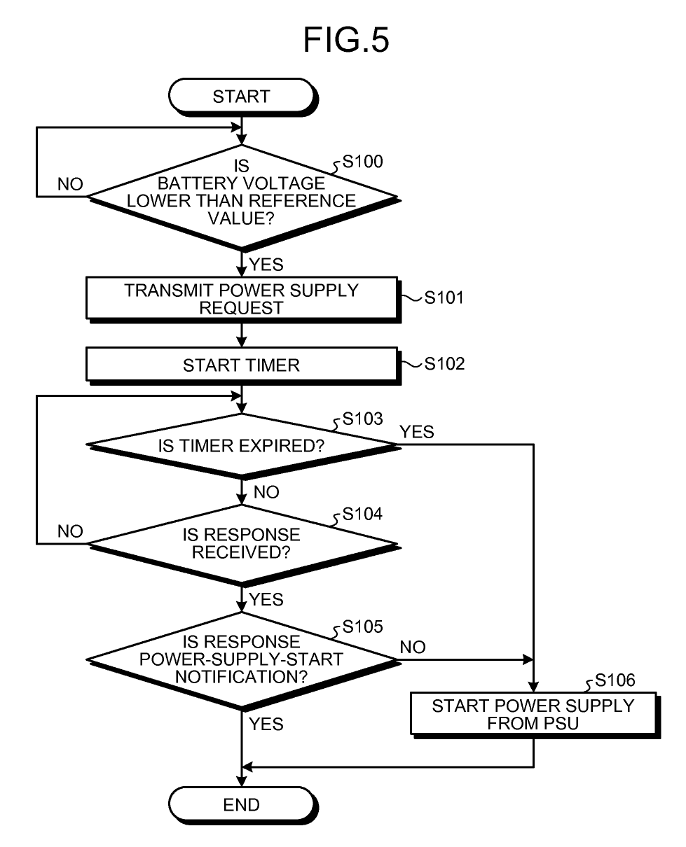

Processing to be performed on a power supply requester and processing to be performed on a power supplier which performs power supply processing according to a power supply request are described in more detail below. FIG. 5 is a flowchart illustrating an example processing sequence for the power supply requester. In the description below, it is assumed that the image forming apparatus 100 transmits a power supply request to the image forming apparatus 200.

The power supply controller 120 of the image forming apparatus 100 monitors conditions of the battery 130 and obtains an output voltage of the battery 130. The power supply controller 120 compares the obtained output voltage with the battery-voltage reference value 162 stored in the memory 152 to determine whether the output voltage of the battery 130 is lower than the battery-voltage reference value 162 (Step S100). Upon determining that the output voltage of the battery 130 is equal to or higher than the battery-voltage reference value 162, the power supply controller 120 causes processing at Step S100 to be repeatedly performed to continue monitoring of the battery 130.

Upon determining that the output voltage of the battery 130 is lower than the battery-voltage reference value 162, the power supply controller 120 transmits a power supply request to the power supply controller 220 of the image forming apparatus 200 (Step S101). In this transmission, the power supply controller 120 transmits information indicating an amount of power necessary to maintain the power saving mode of the image forming apparatus 100 to the power supply controller 220 together with the power supply request.

The power supply controller 120 causes a timer (not shown) to start counting (Step S102). This time count may alternatively be performed using the RTC 151 of the subunit 150. It is determined that the timer has expired when a count value of the timer reaches a predetermined value. The count value at which the timer is determined to have expired can be set as desired.

The power supply controller 120 determines whether the timer has expired (Step S103). Upon determining that the timer has not expired yet, the power supply controller 120 causes processing to proceed to Step S104 where whether a response to the power supply request transmitted at Step S101 has been received is determined. When the power supply controller 120 determines that the response has not been received, processing is returned to Step S103.

Upon determining that the response has been received at Step S104, the power supply controller 120 causes processing to proceed to Step S105 where the power supply controller 120 determines whether the received response is a power-supply-start notification notifying of a start of power supply. The processing sequence indicated in the flowchart illustrated in FIG. 5 ends when the power supply controller 120 determines that the response is the power-supply-start notification.

In this case, operations of the image forming apparatus 100 in the power saving mode are maintained by the power supplied from the image forming apparatus 200. The power supply controller 120 may perform control in a manner such that the battery 130 is charged with power generated by the power generating unit 140 while the image forming apparatus 100 is receiving the power supply from the image forming apparatus 200.

Upon determining that the received response is not the power-supply-start notification (but, for instance, a power-supply-denial notification) at Step S105, the power supply controller 120 causes processing to proceed to Step S106 so that power supply from the PSU 300 is started. Note that also when the power supply controller 120 determines that the timer has expired at Step S103, processing proceeds to Step S106 so that power supply from the PSU 300 is started.

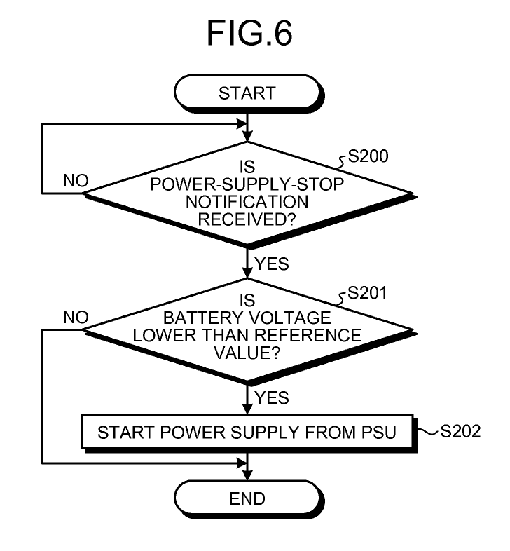

FIG. 6 is a flowchart illustrating an example processing sequence to be performed when the power supply requester receives a power-supply-stop notification from a power supplier. In the description below, it is assumed that the image forming apparatus 100 is the power supply requester, and the image forming apparatus 200 is the power supplier. It is also assumed that the image forming apparatus 100 is already receiving power supply from the image forming apparatus 200 according to the sequence described above indicated in the flowchart illustrated in FIG. 5.

The power supply controller 120 determines whether a power-supply-stop notification has been received from the power supply controller 220 of the image forming apparatus 200 (Step S200). When the power supply controller 120 determines that the power-supply-stop notification has not been received yet, processing at Step S200 is repeatedly performed.

Upon determining that the power-supply-stop notification has been received, the power supply controller 120 causes processing to proceed to Step S201. The power supply controller 120 detects conditions of the battery 130 and obtains an output voltage of the battery 130 (Step S201). The power supply controller 120 compares the obtained output voltage with the battery-voltage reference value 162 stored in the memory 152 to determine whether the output voltage of the battery 130 is lower than the battery-voltage reference value 162.

The processing sequence indicated in the flowchart illustrated in FIG. 6 ends when the power supply controller 120 determines that the output voltage of the battery 130 is equal to or higher than the battery-voltage reference value 162. In this case, the power supply controller 120 can perform control in a manner such that the battery 130 is used as the power source of the image forming apparatus 100.

Upon determining that the output voltage of the battery 130 is lower than the battery-voltage reference value 162, the power supply controller 120 causes processing to proceed to Step S202 so that power supply from the PSU 300 is started.

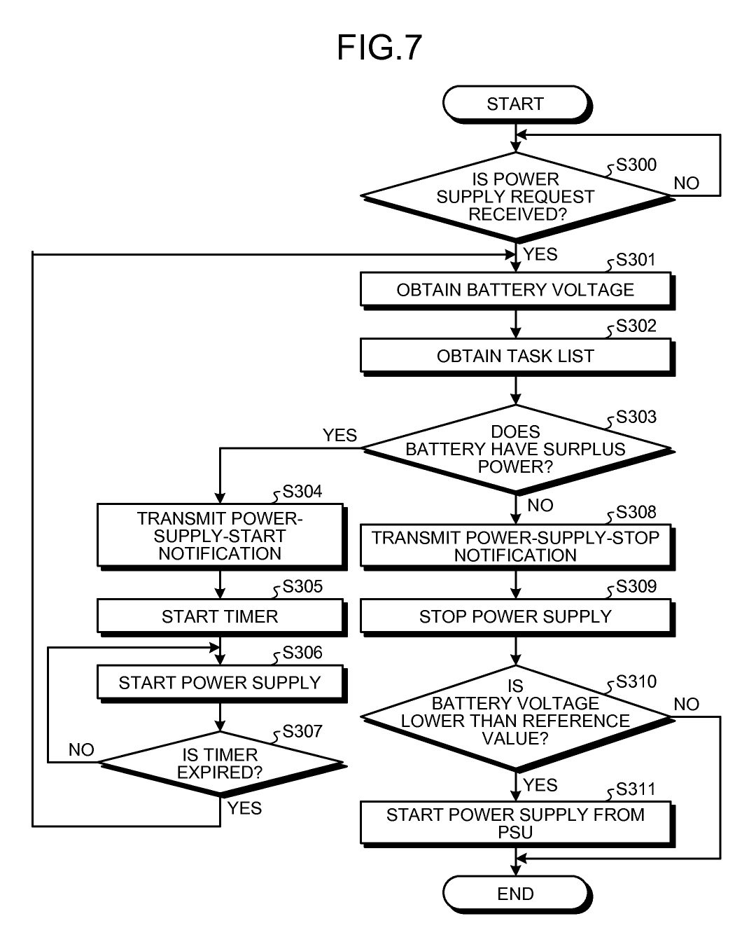

FIG. 7 is a flowchart illustrating an example processing sequence for the power supplier. In the description below, it is assumed that the image forming apparatus 100 is the power supply requester, and the image forming apparatus 200 is the power supplier.

The power supply controller 220 determines whether a power supply request has been received from the power supply controller 120 of the image forming apparatus 100 (Step S300). When the power supply controller 220 determines that a power supply request has not been received, processing at Step S300 is repeatedly performed.

Upon determining that a power supply request has been received from the power supply controller 120, the power supply controller 220 detects conditions of the battery 230 and obtains an output voltage of the battery 230 (Step S301). The power supply controller 220 then retrieves the task list from the memory 252 (Step S302).

The power supply controller 220 determines whether the battery 230 has surplus power enough to supply power to the image forming apparatus 100 (Step S303). Upon determining that the battery 230 has surplus power, the power supply controller 220 causes processing to proceed to Step S304. The determination as to whether the battery 230 has surplus power will be described in detail later.

The power supply controller 220 transmits a power-supply-start notification to the power supply controller 120 of the image forming apparatus 100 to notify of a start of power supply (Step S304). The power supply controller 220 then causes a timer (not shown) to start counting (Step S305). This time count may alternatively be performed using the RTC 251 of the subunit 250. It is determined that the timer has expired when a count value of the timer reaches a predetermined value. The count value at which the timer is determined to have expired can be set as desired.

The power supply controller 220 starts power supply to the image forming apparatus 100 by supplying the output of the battery 230 to the image forming apparatus 100 through the feed line 403 (Step S306). The power supply controller 220 determines whether the timer that has started counting at Step S305 has expired (Step S307). Upon determining that the timer has not expired yet, the power supply controller 220 causes processing to return to Step S306 so that the power supply is continued.

Upon determining that the timer has expired at Step S307, the power supply controller 220 causes processing to return to Step S301 so that a series of operations including condition detection of the battery 230 is repeatedly performed. More specifically, while the output of the battery 230 is supplied to the image forming apparatus 100, the power supply controller 220 detects conditions of the battery 230 and determines whether the battery 230 has surplus power enough to supply power to the image forming apparatus 100 each time when the timer expires. Accordingly, over power supply can be prevented.

As described above, the counter value at which the timer expires can be set as desired. Accordingly, whether the battery 230 has surplus power can be determined more accurately by setting the counter value at which the timer expires to a lower value, for example. It is also possible to decrease an operation rate of the power supply controller 220 by setting the counter value at which the timer expires to a larger value, for example.

Upon determining that the battery 230 does not have surplus power enough to supply power to the image forming apparatus 100 at Step S303, the power supply controller 220 causes processing to proceed to Step S308. The power supply controller 220 transmits a power-supply-stop notification to the power supply controller 120 of the image forming apparatus 100 (Step S308). The power supply controller 220 then stops supplying power to the image forming apparatus 100 from the battery 230 (Step S309).

The power supply controller 220 detects conditions of the battery 230 and obtains an output voltage of the battery 230 (Step S310). The power supply controller 220 compares the obtained output voltage with the battery-voltage reference value stored in the memory 252 to determine whether the output voltage of the battery 230 is lower than the battery-voltage reference value.

The processing sequence indicated in the flowchart illustrated in FIG. 7 ends when the power supply controller 220 determines that the output voltage of the battery 230 is equal to or higher than the battery-voltage reference value stored in the memory 252. In this case, the power supply controller 220 can perform control in a manner such that the battery 230 is used as the power source of the image forming apparatus 200.

Upon determining that the output voltage of the battery 230 is lower than the battery-voltage reference value stored in the memory 252, the power supply controller 220 causes processing to proceed to Step S311 so that power supply from the PSU 300 is started.

Determination to be made at Step S303 as to whether the battery 230 has surplus power enough to supply power to the image forming apparatus 100 is described in more detail below. The surplus power of the battery 230 can be determined based on, for example, estimated power consumption of the image forming apparatus 200 in a period from the point in time (current) of the determination to the scheduled return time at which the image forming apparatus 200 is scheduled to return from the power saving mode, an amount of power requested in the power supply request, and the residual battery power of the battery 230.

For example, the battery 230 is determined to have surplus power enough to supply power to the image forming apparatus 100 when an amount of power calculated by subtracting the estimated power consumption of the image forming apparatus 200 from the residual battery power of the image forming apparatus 200 is higher than the amount of requested power. The residual battery power of the battery 230 is obtained by the power supply controller 220 as one of the battery conditions, for example. An example method to be performed by the power supply controller 220 to obtain the residual battery power is to obtain time-series data about the output voltage of the battery 230, thereby determining an output voltage value and a rate of output-voltage decrease.

Estimated power consumption W_{PRE} can be obtained from Equation (1) below using scheduled return time t_{B}, current time t₀, average power consumption W_{AVG} in the power saving mode, and total power consumption W_{SUM} to be consumed by tasks in a period until the scheduled return time t_{B} comes.

W_{PRE}=(t_{B}−t₀)×W_{AVG}+W_{SUM} (1)

The scheduled return time stored in the memory 252 is used as the scheduled return time t_{B}. The current time t₀ can be obtained using the RTC 251. A predetermined value can be used as the average power consumption W_{AVG} in the power saving mode. Alternatively, the average power consumption W_{AVG} may be measured during the power saving mode and stored in the memory 252. The total power consumption W_{SUM} to be consumed by the tasks in the period until the scheduled return time t_{B} comes can be obtained by multiplying power consumption values of the tasks by a difference between the scheduled return time t_{B} and the current time t₀. The power consumption values of the tasks can be obtained from the task list stored in the memory 252.

Concerning this calculation, a configuration in which priority levels are assigned to the tasks stored in the task list, and any task of which priority level is equal to or lower than a predetermined level is not processed can be employed. With this configuration, power consumption of the task(s) of which priority level is equal to or lower than the predetermined level can be excluded from the total power consumption W_{SUM}. This makes it possible to perform power supply from the battery 230 for a longer period of time.

Surplus power of the battery 230 is not necessarily determined based on the estimated power consumption W_{PRE}, the requested power, and the residual battery power. For example, it is possible to determine that the battery 230 has surplus power when the output voltage of the battery 230 obtained at Step S301 is equal to or higher than the battery-voltage reference value stored in the memory 252.

Thus, according to the embodiment, one of the plurality of apparatuses connected to each other transmits a power supply request to another apparatus of the apparatuses when the one apparatus determines that the power saving mode cannot be maintained using a first battery included in the one apparatus based on detected conditions of the first battery. In response to the power supply request from the one apparatus, the other apparatus starts supplying power to the one apparatus from a battery included in the other apparatus when the other apparatus determines that the battery has surplus power based on detected conditions of the battery. Thus, power supply between the batteries of the apparatuses connected to each other can be controlled without using an apparatus that intermediates the power supply.

### MODIFICATIONS

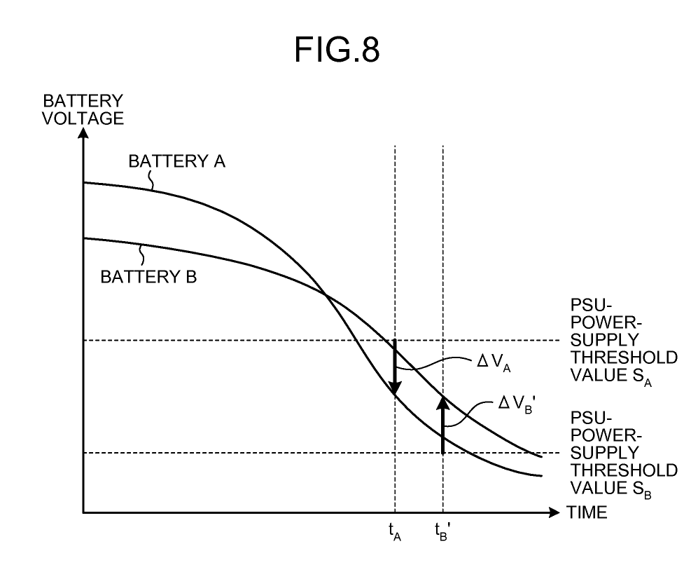

Modifications of the embodiment of the invention are described below. In a modification, scheduled return time for returning from the power saving mode is set to time earlier than the scheduled return time of the embodiment that is set when the image forming apparatus enters the power saving mode. An example is described below with reference to FIG. 8. In this example, scheduled return time for the image forming apparatus 200 of which power consumption in the power saving mode is smaller than that of the image forming apparatus 100 is set to scheduled return time t_{B}′ that is earlier than the scheduled return time t_{B} of the embodiment described above with reference to FIG. 4.

The scheduled return time t_{B}′ for the image forming apparatus 200 that consumes a smaller amount of power in the power saving mode is set to be earlier than the scheduled return time t_{B} of the embodiment in this way. This makes the output voltage of the battery at the scheduled return time t_{B}′ to be higher than the PSU-power-supply threshold value S_{B} by voltage ΔV_{B}′, which is higher than the voltage ΔV_{B}. Accordingly, with this modification, it is possible to make a total amount of power suppliable from the battery 230 of the image forming apparatus 200 to the image forming apparatus 100 is greater than that of the embodiment in which the scheduled return time is the scheduled return time t_{B}. With this modification, the image forming apparatus 200 starts power supply from the PSU 300 in the power saving mode earlier than that in the embodiment. By virtue of these, this modification makes it possible to distribute power of the batteries 130 and 230 more efficiently to thereby reduce power consumption of the commercial power source.

It is also possible to set the PSU-power-supply threshold value S_{A} for the image forming apparatus 100 that consumes a larger amount of power in the power saving mode to a value higher than the PSU-power-supply threshold value S_{A} of the embodiment. This makes it possible to advance time when the image forming apparatus 100 transmits the power supply request to the image forming apparatus 200 so that power of the batteries 130 and 230 can be distributed more efficiently.

According to the embodiments, an effect that power receiving and power supply between batteries of apparatuses can be controlled without using an apparatus that performs centralized management of the power supply and receiving.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A power-supply control system comprising a plurality of apparatuses connected to each other, each of the apparatuses comprising
a battery configured to supply power in a power saving mode where power consumption is lower than in a normal mode;
a detecting unit configured to detect an output voltage of the battery;
a transmitting unit configured to transmit a power supply request when the output voltage is determined to be lower than a predetermined value;
a receiving unit configured to receive a power supply request from another apparatus;
a determining unit configured to determine whether the battery is available; and
a power-supply control unit configured to control power supply from the battery, wherein
the determining unit determines whether the battery is available for the another apparatus in response to the power supply request, and
the power-supply control unit transmits a notification of power supply start to the another apparatus and causes the battery to supply power to the another apparatus when the determining unit determines that the battery is available for the another apparatus.

2. The power-supply control system according to claim 1, wherein
the determining unit determines whether the battery is available for the another apparatus every time the battery supplies power to the another apparatus over a predetermined time period, and
the power-supply control unit causes the battery to continue to supply power to the another apparatus when the battery is available for the another apparatus.

3. The power-supply control system according to claim 1, wherein
each of the apparatuses further comprises a storage unit configured to store information indicating scheduled return time at which the each of the apparatuses is scheduled to return to the power saving mode, information indicating power consumption per unit time of a task to be performed in the power saving mode, and information indicating average power consumption per unit time in the power saving mode, and
the determining unit calculates estimated power consumption in a period until the scheduled return time comes, based on the information indicating the scheduled return time, the information indicating the power consumption per unit time, and the information indicating the average power consumption per unit time, and
the determining unit determines that the battery is available for the another apparatus when a power obtained by subtracting the estimated power consumption from residual power of the battery is greater than a power requested in the power supply request.

4. The power-supply control system according to claim 3, wherein the scheduled return time stored in the storage unit is time earlier than scheduled return time that is set when the apparatus enters the power saving mode.

5. The power-supply control system according to claim 3, wherein
the storage unit stores information about a plurality of tasks to be performed, priority levels being assigned to the tasks, and
the determining unit excludes power consumption per unit time of every task whose priority level is equal to or lower than a predetermined level from total power consumption per unit time of the tasks to be performed in the power saving mode, to determine whether the battery is available for the another apparatus.

6. The power-supply control system according to claim 1, wherein
each of the apparatus further comprises a power generating unit configured to generate power, and
the battery is charged with the power generated by the power generating unit.

7. A power-supply control method comprising:
detecting, by a detecting unit, an output voltage of a battery;
transmitting, by a transmitting unit, a power supply request when the output voltage is determined to be lower than a predetermined value;
receiving, by a receiving unit, a power supply request from an apparatus;
determining, by a determining unit, whether the battery is available; and
controlling, by a power-supply control unit, power supply from the battery, wherein
the determining includes determining whether the battery is available for the apparatus in response to the power supply request, and
the controlling includes transmitting a notification of power supply start to the apparatus and causing the battery to supply power to the apparatus when the battery is available for the apparatus.

8. An image forming apparatus comprising:
an image forming unit configured to form an image based on image data;
a detecting unit configured to detect an output voltage of a battery;
a transmitting unit configured to transmit a power supply request when the output voltage is determined to be lower than a predetermined value;
a receiving unit configured to receive a power supply request from an apparatus;
a determining unit configured to determine whether the battery is available; and
a power-supply control unit configured to control power supply from the battery, wherein
the determining unit determines whether the battery is available for the another apparatus in response to the power supply request,
the power-supply control unit transmits a notification of power supply start to the another apparatus and causes the battery to supply power to the another apparatus when the determining unit determines that the battery is available for the another apparatus, and
the power-supply control unit feeds power supplied in response to the power supply request transmitted by the transmitting unit, to the image forming unit.
